(19) United States
(12) Patent Application Publication
(10) Pub. No.: US 2006/0277576 A1
(43) Pub. Date: Dec. 7, 2006

(54) Signal distribution system with user-defined channel comprising information from an external network

(76) Inventors: Swarup Acharya, New Providence, NJ (US); Anurag Srivastava, Roselle, NJ (US)

Correspondence Address: RYAN, MASON & LEWIS, LLP, 90 FOREST AVENUE, LOCUST VALLEY, NY, 11560, US

(21) Appl. No.: 11/145,832

(22) Filed: Jun. 6, 2005

(51) Int. Cl. H04N 5/445; H04N 7/10; G06F 3/00; G06F 13/00; H04N 7/025

(52) U.S. Cl. 725/46; 725/45; 725/34; 725/35

(57) ABSTRACT

A user-defined channel, comprising content specified by a system user, is provided as one of a plurality of channels of a subscription service in a signal distribution system. At least a portion of the content specified by the system user is obtained from a network external to the subscription service provider network. At least one media stream comprising the content is generated, and delivered via an interface device associated with the system user in conjunction with the subscription service. In one embodiment, the user-defined channel comprises a tracking channel, and the specified content comprises location information that is obtained from the external network and identifies a location of at least one entity specified by the system user.

### RELATED APPLICATIONS

This application is related to U.S. patent application Ser. No. 11/130,329, filed May 16, 2005 and entitled “Method and Apparatus for Providing Remote Access to Subscription Television Services,” which is incorporated by reference herein.

### FIELD OF THE INVENTION

The present invention relates generally to signal distribution systems, and more particularly to techniques for distributing media streams associated with user-defined channels in cable television systems, satellite television systems, Internet protocol television (IPTV) systems, and other types of signal distribution systems.

### BACKGROUND OF THE INVENTION

Conventional signal distribution systems include, by way of example, cable television systems, satellite television systems, and systems providing IPTV over digital subscriber line (DSL) or fiber. Such systems are configured to distribute media streams associated with subscription television services to system subscribers or other users. Subscription television services are usually tied to a particular household or other predetermined subscriber location. Typically, a given subscriber is provided with an interface device, such as a set-top box or receiver, for communicating with system head end equipment. The interface device is configured to permit the subscriber to receive, on a television or other presentation device coupled to the interface device at a home location, the particular subscription television services to which that subscriber is entitled by virtue of the subscription. A given subscription may encompass, by way of example, a number of basic broadcast channels, as well as one or more premium programming channels, such as movie channels, sports channels, specialty channels, pay-per-view channels, on-demand video channels, etc.

A serious drawback of conventional cable, satellite and IPTV systems is that there is typically no roaming capability provided for subscribers. That is, subscribers generally must be at their respective home locations in order to receive the television services to which they have subscribed. By way of example, if a first subscriber leaves his or her home location and visits a remote location that also serves as a home location for a second subscriber, there is no mechanism provided for allowing the first subscriber to access his or her subscription television services at the second subscriber location. Thus, if the first subscriber has paid for access to a premium programming channel at his or her home location, that subscriber has no ability to access the premium programming channel at the remote location. This is the case even if the remote location, that is, the home location of the second subscriber, has the same television service provider and type of interface device as the home location of the first subscriber.

The above-cited U.S. patent application Ser. No. 11/130,329 discloses techniques which address and solve the remote accessibility problem. In one embodiment disclosed therein, an arrangement is provided whereby subscribers can access their usual home location subscription television services when at remote locations, without the need for carrying media devices, communications devices or other equipment to the remote locations.

Despite the considerable advances provided by the techniques described in U.S. patent application Ser. No. 11/130,329, a need remains for further improvements in providing user accessibility to content via cable, satellite and IPTV systems, as well as other types of signal distribution systems.

### SUMMARY OF THE INVENTION

The present invention in an illustrative embodiment meets the above-identified need by providing users of a cable, satellite or IPTV system, or other type of signal distribution system, with access to user-defined content that is obtained by a service provider from one or more external networks.

In accordance with an aspect of the invention, a user-defined channel, comprising content specified by a system user, is provided as one of a plurality of channels of a subscription service in a signal distribution system. At least a portion of the content specified by the system user is obtained from a network external to the subscription service provider network. At least one media stream comprising the content is generated, and delivered via an interface device associated with the system user in conjunction with the subscription service.

In one embodiment, the user-defined channel comprises a tracking channel, and the specified content comprises location information. The location information is obtained from an external wireless network with mobile device location capability, and identifies a location of at least one entity, such as a particular family member, specified by the system user.

In another embodiment, the user-defined channel comprises a video monitoring channel, and the specified content comprises one or more video signals obtained from the external network and associated with particular monitored locations specified by the system user. In such an arrangement, the external network may comprise a home network of the system user, with the video signals being sourced from video cameras coupled to the home network at the monitored locations.

In the television subscription service context, the user-defined channels may be viewable on a television or other presentation device like any other channel of the subscription service. For example, a television service provider may allocate a specified range of channels for utilization as user-defined channels, such as channels 300 to 305, with a particular one of the channels being selected for viewing by tuning a set-top box, receiver or other interface device to the corresponding channel number.

Moreover, user-defined channels may be delivered to home or remote locations of subscribers, so as to accommodate roaming subscribers.

Advantageously, the present invention in the illustrative embodiments facilitates access to user-defined content in cable, satellite, IPTV and other signal distribution systems, thereby enhancing the user experience while also providing a significant source of additional revenue for service providers.

### BRIEF DESCRIPTION OF THE DRAWINGS

FIG. 1A shows an illustrative embodiment of a signal distribution system in accordance with the invention.

FIG. 1B shows a simplified block diagram of an interface device of the FIG. 1A system.

FIG. 2 is a flow diagram illustrating the operation of the FIG. 1A system under various operating scenarios of the illustrative embodiment.

FIG. 3 shows an example of a display that may be generated for a user-defined tracking channel in the FIG. 1A system.

FIGS. 4A and 4B show examples of signal distribution systems configured to provide delivery of user-defined channels to subscribers.

### DETAILED DESCRIPTION OF THE INVENTION

The invention will be illustrated herein in conjunction with illustrative embodiments of signal distribution systems. It should be understood, however, that the invention is not limited to use with the particular systems and techniques described, but is instead more generally applicable to any signal distribution application in which it is desirable to provide improved access to content for system users. For example, although described herein primarily in the context of subscription television services, the techniques of the invention can also be adapted in a straightforward manner to subscription audio services, such as those delivered via digital satellite radio systems. Systems of the latter type are considered a type of signal distribution system as that term is used herein.

The term “subscription” as used herein is intended to include a variety of arrangements for charging a user for access to media streams, and should not be construed as requiring any particular type of billing arrangement or regular access period, such as weekly, monthly, yearly, etc.

As noted above, U.S. patent application Ser. No. 11/130,329 discloses techniques whereby subscribers can access their usual home location subscription television services when at remote locations. These and other roaming access techniques may be utilized in conjunction with the present invention. However, it is to be understood that the invention does not require any roaming functionality at all, and may be implemented, by way of example, in an embodiment in which user-defined channels are delivered only to home locations of subscribers, and not made accessible at remote locations. Nonetheless, the invention will be described herein in the context of a signal distribution system which may also provide a roaming capability such as that described in U.S. patent application Ser. No. 11/130,329.

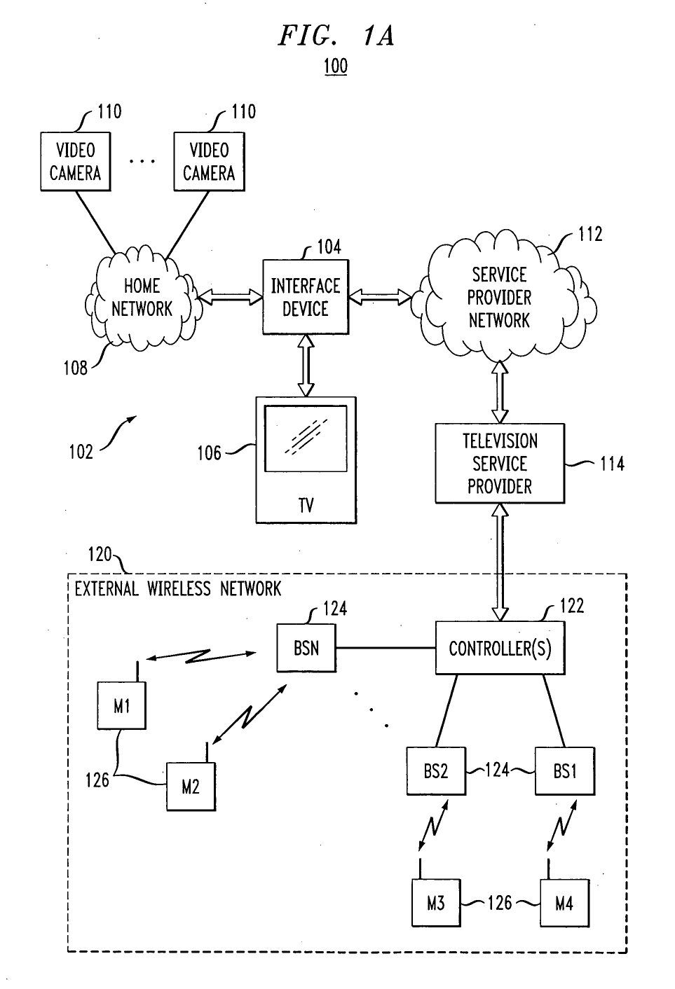

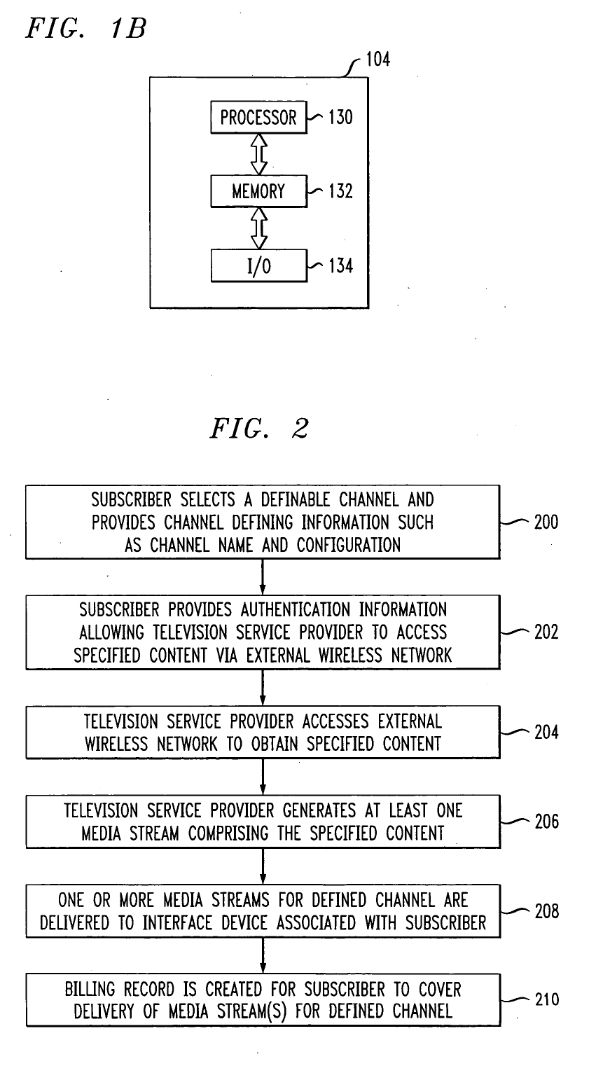

Referring now to FIG. 1A, a signal distribution system 100 comprises a subscriber location 102 which includes an interface device 104. The interface device is coupled to a television 106 and to a home network 108. Also coupled to the home network 108 is a plurality of video cameras 110. The interface device 104 is coupled via a service provider network 112 to a television service provider 114. The television service provider 114 communicates with an external wireless network 120.

The subscriber location 102 is assumed in this embodiment to be a home location of a subscriber, but may alternatively be viewed as a remote location of the subscriber, as those terms are described in the above-cited U.S. patent application Ser. No. 11/130,329. As noted therein, the home location for a given subscriber may be the remote location for another subscriber.

The signal distribution system 100 may comprise, by way of example, a cable television system, a satellite television system, a system for providing IPTV over DSL or fiber, or portions or combinations of these and other systems. Element 114 may comprise, for example, otherwise conventional service provider head end equipment, including, for example, cable head end systems, satellites, servers, etc.

The interface device 104 may comprise, for example, a set-top box, a receiver, a computer, or one or more other processor-based devices, in any combination. The interface device may be a stand-alone device, or may be combined with the television 106 into a single device.

It should be noted that the invention does not require the use of a television or any other particular type of presentation arrangement. For example, subscription television services could be delivered to a computer, mobile telephone, personal digital assistant (PDA), or other type of processor-based device using the techniques of the invention. Such devices are therefore intended to be included within the scope of the term “interface device” as used herein. A given interface device may therefore, by way of example, combine interface functionality with television display functionality.

The network 112 may comprise any type of communication network suitable for transporting signals associated with the provision of subscriber television services, and the invention is not limited in this regard. For example, portions of the network 112 may comprise local area networks, wide area networks, the Internet, satellite networks, cellular telephone networks, IEEE 802.11 networks, etc.

The external wireless network 120 may be, for example, a cellular network configured in accordance with well-known standards such as GSM, CDMA 2000 or UMTS, or any other type of wireless network suitable for providing location information regarding mobile users. As will be described in greater detail below, such location information may be utilized to provide specified content in a user-defined tracking channel in system 100 in an illustrative embodiment of the invention. The wireless network 120 is referred to as “external” herein in that it is external to the service provider network 112 and the equipment associated with the television service provider 114. The home network 108 may be viewed as another example of an external network in this sense.

Included in the external wireless network 120 is at least one controller 122 coupled to a plurality of base stations 124. The base stations 124, also denoted as base stations BS1, BS2, . . . BSN, communicate with a plurality of mobile devices 126, also denoted as mobile devices M1, M2, M3 and M4, as shown. The controller(s) 122 may comprise, for example, one or more radio network controllers (RNCs). The mobile devices 126 may be viewed as examples of what are more generally referred to herein as communication devices. Of course, the system may include a substantially larger number of mobile devices, base stations and RNCs or other controllers, as well as additional elements not explicitly shown, as will be appreciated by those skilled in the art.

Conventional aspects of the operation of external wireless network 120 are well known to those skilled in the art, and therefore not described in detail herein.

External wireless network 120 may implement mobile device location functionality, such as that described in U.S. Patent Application Publication No. 2004/0235492, entitled “Apprising System for Use with a Cellular Telephone and a Method of Operation Thereof,” and U.S. Patent Application Publication No. 2004/0259522, entitled “Method and Apparatus for Design of Wireless Networks to Aid in Location Identification of Mobile Units,” both of which are incorporated by reference herein. However, the invention does not require the use of any particular network-based mobile device location technique.

As noted above, the subscriber location 102 in this embodiment is a designated home location of a particular system subscriber. Thus, it is a location at which the subscriber is permitted to access one or more television services by virtue of his or her subscription. It should be noted that the term “subscriber” as used herein is intended to encompass other subscribing entities, such as businesses or organizations, in addition to individuals or families. Subscribers may be viewed as examples of what are more generally referred to herein as users, and the term “user” is thus intended to include subscribers as well as other types of users.

Also, the term “home” should be construed broadly, and is not intended to be restricted to individual or family residences. Instead, the home location of a particular subscriber may be a primary location of that subscriber, or more generally any location at which that subscriber ordinarily accesses subscription services in accordance with the subscription. A home location may therefore be at a business facility, hotel or other building, in a means of conveyance such as an automobile, train, bus or airplane, or at any other suitable location. A “remote” location may be a secondary location of a given subscriber, or more generally any location other than the home location for that subscriber. For example, a remote location may be a room or other area in a hotel or means of conveyance that is intended to serve multiple subscribers over a given period of time.

FIG. 1B shows one possible implementation of the interface device 104. The interface device 104 in this embodiment comprises aprocessor 130, a memory 132, and input/output (I/O) elements 134. The processor 130 may be, e.g., a microprocessor, a microcontroller, an application-specific integrated circuit (ASIC) or other type of processing device, as well as portions or combinations of such devices. The memory 132 may include an electronic random access memory (RAM), a read-only memory (ROM) or other type of storage device, as well as portions or combinations of such devices. The processor 130 and memory 132 are used in storage and execution of one or more software programs for implementing user-defined channels of a type to be described in greater detail below.

The particular signal distribution system configuration described above should be viewed as an illustrative example of a user-defined channel arrangement in accordance with the invention, and it is to be understood that the invention can be implemented using other types and configurations of system components.

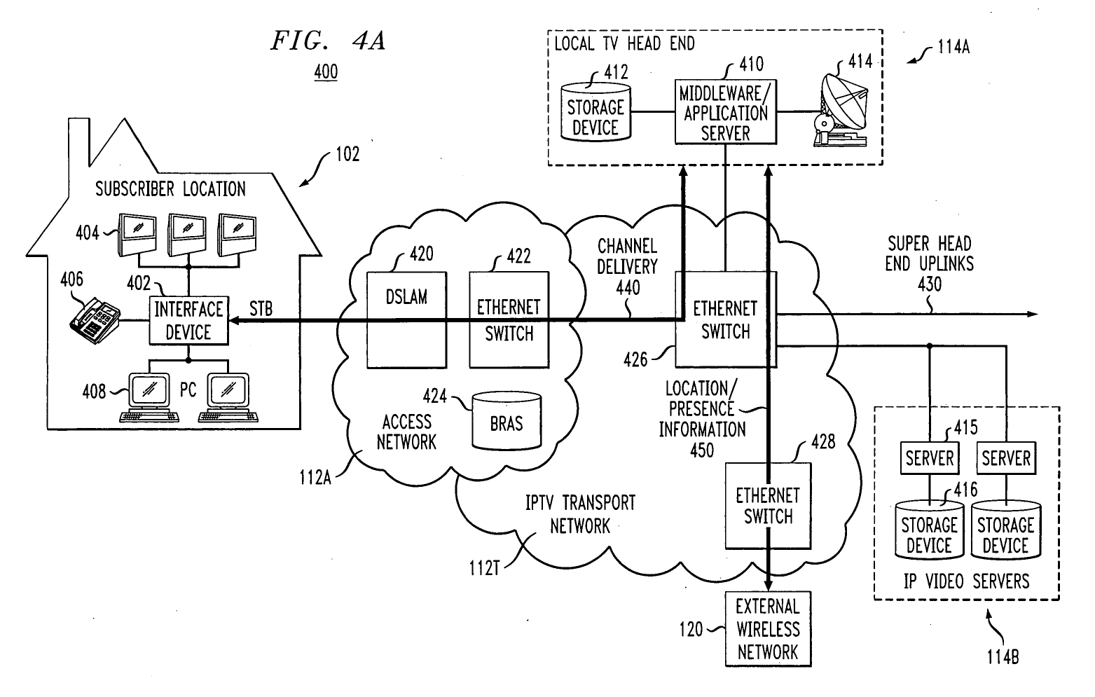

In accordance with an aspect of the invention, the signal distribution system 100 is configured to provide one or more user-defined channels in conjunction with otherwise conventional subscription television services. A given user-defined channel comprises content specified by a subscriber or other system user. For example, in one embodiment, to be described in greater detail in conjunction with FIG. 3, the user-defined channel comprises a tracking channel, and the specified content comprises location information that is obtained from the external wireless network 120 and identifies a location of at least one entity specified by the system user. As another example, the user-defined channel may comprise a video monitoring channel, with the specified content comprising one or more video signals, obtained from respective ones of the video cameras 110 coupled to home network 108, and associated with one or more particular monitored locations specified by the system user.

In the foregoing examples, the user-defined channels may be viewable on television 106, or on another media presentation device, in substantially the same manner as any non-user-defined channel of the subscription service. For example, a television service provider may allocate a specified range of subscription television channels for utilization as user-defined channels, such as channels 300 to 305 in a system having subscription television channels one to 999. A particular one of the channels, either user-defined or non-user-defined, may be selected for viewing by tuning a set-top box, receiver or other type of interface device 104 to the corresponding channel number. The service provider may have different subscription plans with different numbers of user-defined channels, with subscription charges being based on the number of user-defined channels.

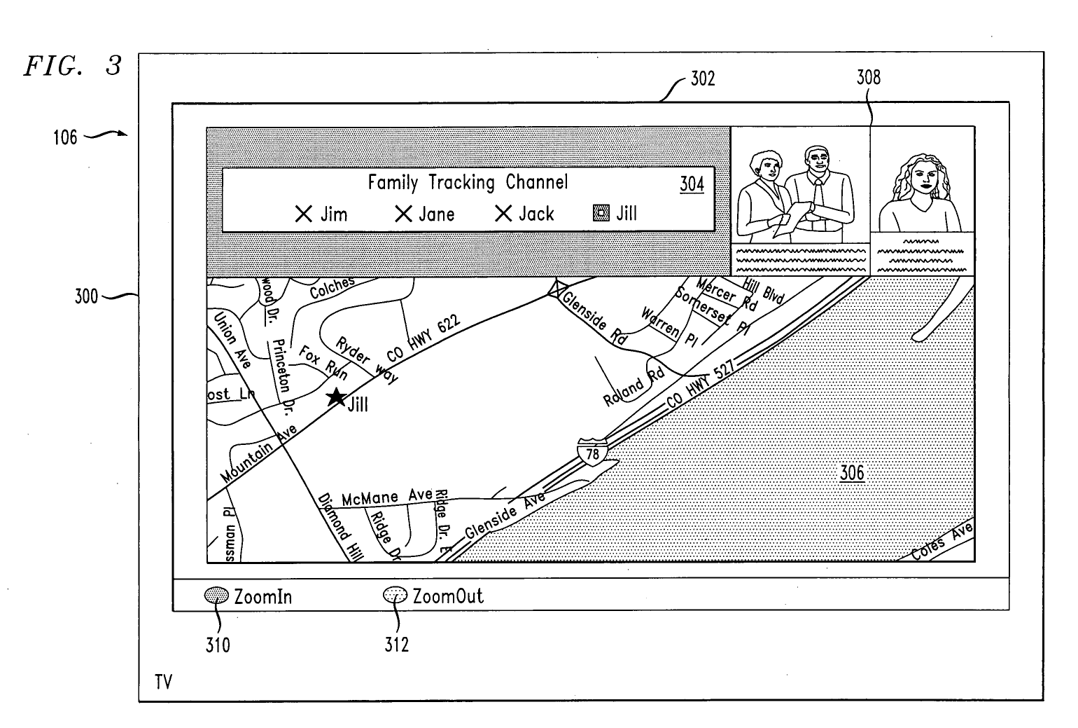

FIG. 2 is a flow diagram illustrating the operation of system 100 in providing a user-defined channel using content obtained from the external wireless network 120. This exemplary process is implemented at least in part in the form of software that is executed by system elements such as interface device 104 and the head end equipment of the television service provider 114.

In step 200 the subscriber selects a definable channel and provides channel defining information such as channel name, configuration, etc. For example, the user may select a particular unused channel to serve as a tracking channel or a video monitoring channel. The selected channel may be a next available definable channel, or selected based on user preference from among a set of definable channels.

In step 202, the subscriber provides authentication information via the interface device 104 which permits the television service provider to access the external wireless network on behalf of the subscriber. Such authentication information may comprise, for example, an account name and password for a user account on the external wireless network 120. It is to be appreciated that such authentication information may be of a type that normally would be utilized by the subscriber in accessing the external network via an associated mobile device, such as one of the devices M1, M2, M3 or M4 of FIG. 1A. However, the term “authentication information” as used herein is intended to be construed broadly, so as to cover any type of information suitable for establishing the entitlement of the subscriber to content available from the external wireless network.

The inputs called for in steps 200 and 202 may be provided, by way of example, via the interface device 104, using a remote control or other entry device in conjunction with an on-screen user interface display generated by the interface device and presented to the subscriber via the television 106. Any such inputs entered by the subscriber may be transmitted over network 112 to the television service provider 114, as needed. For example, authentication information required by the service provider to access the external wireless network on behalf of the subscriber may be transmitted in such a manner. Other information that relates to configuration functionality implemented solely at the interface device need not be explicitly transmitted to the service provider 114.

The input information can be provided by the subscriber using any suitable technique. For example, the subscriber may manually enter the information and then enter a transmit command, or the process may occur automatically, with the information, other than a password or other secure information, being transferred wirelessly from a device carried by the subscriber to the interface device. Clearly, a wide variety of alternative techniques are possible for entering, storing, transferring, transmitting or processing the input information.

In step 204, the television service provider 114 accesses the external wireless network 120 on behalf of the subscriber to obtain the specified content.

In step 206, the television service provider 114 generates at least one media stream comprising the specified content obtained in step 204.

In step 208, the one or more media streams for the user-defined channel are delivered to the interface device 104 in conjunction with the subscription service. Thus, the user-defined channel is delivered as one of the plurality of channels of the subscription service.

It should be noted that delivery of the media stream(s) in step 208 may involve adaptation of the stream(s) to meet the particular display requirements of the subscriber location. For example, transcoding or other adaptation may be applied to the media stream(s) using suitable interworking functions implemented at the subscriber location, in the head end equipment, or elsewhere in the signal distribution system.

As indicated in step 210, a billing record is created for the subscriber, typically by the service provider, in order to cover delivery of the media stream(s) of the user-defined channel to the subscriber location. This advantageously provides an ability for service providers to generate additional revenues from their subscribers. The charges may be included as part of the usual bill that is generated for the home location services of the subscriber. That is, the charges of the billing record created in step 210 may be combined with charges associated with providing access to subscription television services to the subscriber at a home location. Of course, alternative billing arrangements may be used, such as including a certain number of remote accesses within a fixed monthly or yearly fee, and so on.

As mentioned previously, user-defined channels may be made accessible to subscribers at remote locations. Thus, the signal distribution system 100 may be configured to provide a subscriber with accessibility to the user-defined channel at a home location via a first interface device of the system and at a remote location via a second interface device of the system.

FIG. 3 shows an example of a display that may be generated for a user-defined tracking channel in the system 100 of FIG. 1A. This information is presented to the subscriber via the television 106, which comprises a housing 300 and a display 302. The display shows specified content in the form of location information that is obtained from the external wireless network 120 and identifies a location of at least one entity specified by the subscriber. In this case, the tracking channel is configured to provide a family tracking channel, for tracking the locations of various family members including in this example four family members denoted Jim, Jane, Jack and Jill. A first portion 304 of the display 302 indicates a particular one of the family members for whom location information is currently presented in a second portion 306 of the display. A third portion 308 of the display shows a conventional television program, combined with the tracking channel in a picture-in-picture type arrangement, that may be part of the subscription service provided by the television service provider, or may be provided by the television receiver in a conventional manner.

As shown, location information for family member Jill is indicated by a star or other identifier on a displayed map in portion 306. The location information is obtained by the television service provider 114 from the external wireless network 120 in the manner previously described in conjunction with FIG. 2.

The user-defined tracking channel comprises a number of on-screen user control functions. As noted above, one such on-screen user control function comprises an ability to select at least one of a plurality of specified entities for which location information obtained from the external wireless network is to be displayed. This selection is achieved in the present embodiment by selecting one or more of the identified family members in portion 304 of the display. Such selection may be implemented using conventional user interface techniques, possibly involving a remote control device which communicates with interface device 104. Another on-screen user control function provided in this embodiment comprises a zoom function permitting the user to zoom in or zoom out on a displayed map, by activating respective icons 310 or 312 of the display. Activation of such icons alters the range covered by the map portion 306 of the display, using well-known techniques.

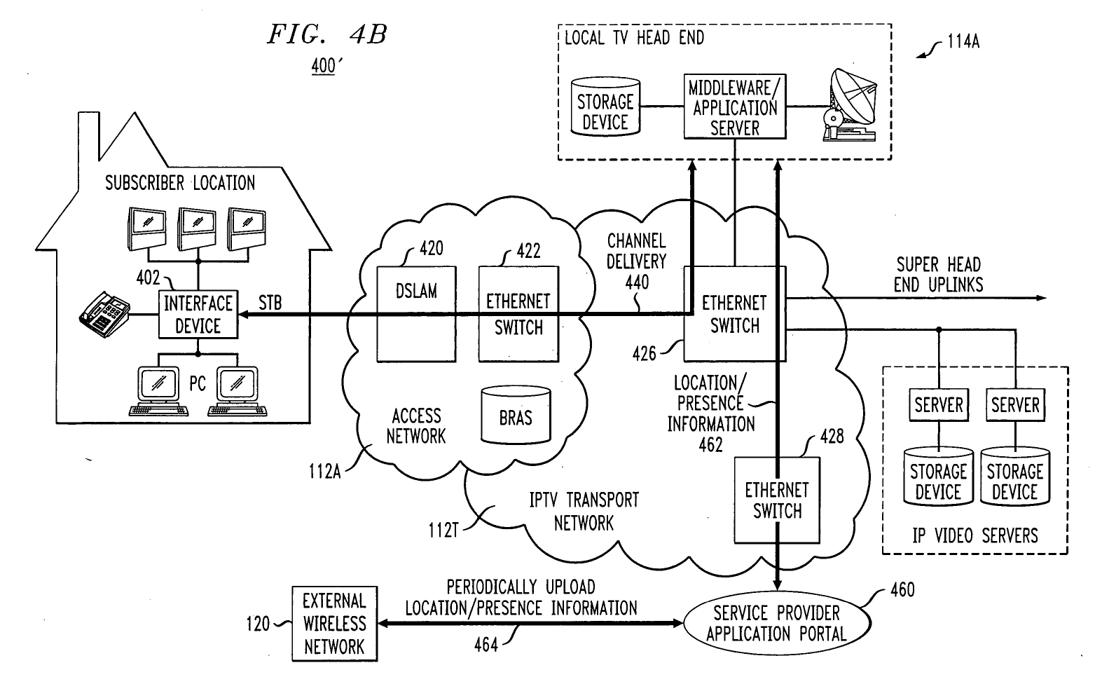

Particular implementations of the FIG. 2 process will now be described with reference to exemplary system diagrams of FIGS. 4A and 4B. The systems and associated processes illustrated in these drawings are examples of the more general system and process described in conjunction with FIGS. 1 and 2, respectively.

In these illustrative embodiments, it is assumed that the subscriber location is coupled to the service provider network via DSL connections. The systems to be described may therefore be viewed as exemplary implementations of systems for providing IPTV over DSL. However, it is to be understood that the invention can be implemented using cable or satellite connections to the subscriber location, IPTV over fiber connections, or other types of connections, in any combination.

Referring initially to FIG. 4A, a signal distribution system 400 is configured to provide one or more user-defined channels to subscriber location 102. The subscriber location 102 comprises an interface device 402 which in this embodiment is assumed to be a set-top box. Also at the home location are televisions 404, a telephone 406 and personal computers (PCs) 408. Such devices may be interconnected by a home network such as home network 108, which also may be coupled to one or more video cameras not explicitly shown in this figure.

The system 400 further includes service provider network 112, more specifically comprising an access network 1 12A and a transport network 1 12T. The network 112 connects the subscriber location 102 to television service provider 114 which more specifically comprises television service provider head end equipment 114A, 114B. Elements 114A and 1 14B are also referred to herein as video head end equipment.

The term “head end equipment” as used herein is intended to be construed generally so as to encompass any type of service provider equipment which may be used to provide one or more media streams to a transport network or other communication channel for delivery to one or more subscribers. Thus, such equipment need not be located at any particular point in a given system. Also, various combinations of different pieces of equipment at different locations in the system may comprise head end equipment as that term is used herein.

The head end equipment 114A in the FIG. 4A embodiment comprises a local television broadcast channel head end which includes a middleware/application server 410, a storage device 412, and satellite communication equipment 414. The head end equipment 114B comprises IP video servers, including servers 415 and storage devices 416.

The access network 112A in this embodiment comprises a DSL access multiplexer (DSLAM) 420 which is coupled via DSL connections to the subscriber location 102. The DSLAM 420 is coupled to the television service provider equipment 114A, 114B via Ethernet switches 422 and 426. A broadband remote access server (BRAS) 424 is associated with the access network 112A.

A user-defined channel of the type described herein may be configured and delivered over the signal path 440.

The head end equipment 114A communicates with external wireless network 120 via Ethernet switch 428 of transport network 1 12T, over signal path 450, in order to obtain location information for presentation in a user-defined tracking channel.

The Ethernet switch 426 also couples to super head end equipment, not explicitly shown in the figure, via connection 430. A super head end generally refers to a combination of multiple head ends subject to common control.

FIG. 4B shows an alternative arrangement in which system 400′ includes substantially the same arrangement of elements as system 400, but further includes a service provider application portal 460 which facilitates interaction between the head end equipment 114A and the external wireless network 120. More specifically, in this embodiment, the head end equipment 114A communicates via Ethernet switch 428 with the application portal 460, over signal path 462. The application portal provides an interface with the external wireless network 120, via signal path 464, for obtaining location information for presentation in a user-defined tracking channel.

The FIG. 4A arrangement may be preferred in applications in which the television service provider and external wireless network are controlled by or otherwise associated with a common ownership entity, while the FIG. 4B arrangement may be preferred in applications in which the television service provider and external wireless network are controlled by respective separate ownership entities.

It is to be appreciated that the particular arrangement of system elements shown in FIGS. 4A and 4B, and other figures herein, is presented by way of illustrative example only. Numerous alternative configurations of system equipment may be used to implement the described user-defined channel techniques. For example, although shown in the FIG. 4A and 4B embodiments as separate elements, the BRAS and DSLAM elements may have their respective functionalities combined into a single network element in an alternative embodiment. Also, although the transport network is shown as comprising Ethernet switches, other types of switches, routers or hubs, in any combination, may be used.

In an embodiment of the invention providing a video monitoring channel of the type mentioned above, interface device 104 coupled to home network 108 may open one or more ports corresponding to this channel for content acquisition on an IP interface of the home network 108. One or more of the video cameras 110 may then be controlled so as to stream content to respective opened ports of the interface device. Numerous alternative arrangements can be used to source content from devices coupled to an interface device for inclusion in a user-defined channel. Video monitoring channels of this type, like other user-defined channels described herein, may be made available to roaming subscribers at remote locations, using the techniques described in the above-cited U.S. patent application Ser. No. 11/130,329. For example, interface device 104 may be configured to deliver content from a subscriber home network 108 to head end equipment of the television service provider such that the content can be made available to that subscriber at a remote location.

Again, the above-described embodiments of the invention are intended to be illustrative only. For example, although described in the context of particular signal distribution systems, the invention is not restricted to use in such systems. The described user-defined channel techniques can be adapted in a straightforward manner to a wide variety of alternative systems, using different arrangements of system elements. As indicated above, the techniques can be applied to a wide variety of subscription media services, including subscription audio services delivered via digital satellite radio, and to other arrangements for delivering signals associated with subscription media services.

Also, the particular manner in which a subscriber provides information to a service provider and receives media streams therefrom at a home or remote location may be varied in alternative embodiments to accommodate the needs of a given application. The authentication information may include, again by way of example, a user account and password, or any other information suitable for identifying a subscriber to the satisfaction of a particular service provider.

Further, the media streams that are delivered as part of a user-defined channel for a given subscriber may include any type of data, including, for example, digital audio, video, speech or other information signals, in any combination.

These and numerous other alternative embodiments within the scope of the following claims will be readily apparent to those skilled in the art.

We claim:

1. A method of providing a user-defined channel as one of a plurality of channels of a subscription service in a signal distribution system, the user-defined channel comprising content specified by a system user, the method comprising the steps of:
obtaining, from a network external to a provider network of the subscription service, at least a portion of the content specified by the system user; and
generating at least one media stream comprising the content;
wherein the media stream is delivered via an interface device associated with the system user in conjunction with the subscription service.

2. The method of claim 1 wherein the network external to the signal distribution system comprises an external wireless network.

3. The method of claim 1 wherein the system user provides authentication information via the interface device which permits a service provider of the subscription service to access the external wireless network on behalf of the system user.

4. The method of claim 1 wherein the user-defined channel comprises a tracking channel.

5. The method of claim 4 wherein the content comprises location information obtained from the external network and identifying a location of at least one entity specified by the system user.

6. The method of claim 4 wherein the tracking channel comprises at least one on-screen user control function.

7. The method of claim 6 wherein the on-screen user control function comprises an ability to select at least one of a plurality of specified entities for which location information obtained from the external network is displayed.

8. The method of claim 6 wherein the on-screen user control function comprises a zoom function permitting the user to zoom in or zoom out on a displayed map.

9. The method of claim 1 wherein the signal distribution system is configured to provide the user with accessibility to the user-defined channel at a home location via a first interface device of the system and at a remote location via a second interface device of the system.

10. The method of claim 1 wherein the subscription service comprises a subscription television service.

11. The method of claim 10 wherein the signal distribution system comprises a cable television system.

12. The method of claim 10 wherein the signal distribution system comprises a satellite television system.

13. The method of claim 10 wherein the signal distribution system comprises a system providing Internet protocol television over at least one of digital subscriber line and fiber.

14. The method of claim 1 further including the step of generating a billing record including charges for provision of the user-defined channel.

15. The method of claim 1 wherein the network external to the signal distribution system comprises a home network of the system user.

16. The method of claim 1 wherein the user-defined channel comprises a video monitoring channel.

17. The method of claim 16 wherein the content comprises one or more video signals obtained from the external network and associated with particular monitored locations specified by the system user.

18. An apparatus for providing a user-defined channel as one of a plurality of channels of a subscription service in a signal distribution system, the user-defined channel comprising content specified by a system user, the apparatus comprising:
an interface device comprising a processor and a memory coupled to the processor;
wherein the processor is operative to control the delivery of at least one media stream comprising the content, in conjunction with the subscription service;
wherein at least a portion of the content specified by the system user is obtained from a network external to a provider network of the subscription service.

19. The apparatus of claim 18 wherein the interface device is configured to include a capability for presenting the media stream.

20. The apparatus of claim 18 wherein the interface device is coupled to a media presentation device which is configured to present the media stream.

21. A signal distribution system for providing a user-defined channel as one of a plurality of channels of a subscription service, the user-defined channel comprising content specified by a system user, the system comprising:
a plurality of interface devices;
head end equipment operative to receive, from a given one of the interface devices associated with the system user, information regarding the specified content, to obtain, from a network external to a provider network of the subscription service, at least a portion of the content specified by the system user, and to generate at least one media stream comprising the content;
wherein the media stream is delivered from the head end equipment to the given interface device in conjunction with the subscription service.

22. An article of manufacture comprising a machine-readable medium storing one or more programs for use in providing a user-defined channel as one of a plurality of channels of a subscription service in a signal distribution system, the user-defined channel comprising content specified by a system user, the one or more programs when executed in a processor performing the steps of:
obtaining, from a network external to a provider network of the subscription service, at least a portion of the content specified by the system user; and
generating at least one media stream comprising the content;
wherein the media stream is delivered via an interface device associated with the system user in conjunction with the subscription service.
